(19) United States
(12) Patent Application Publication
(10) Pub. No.: US 2008/0047720 A1
(43) Pub. Date: Feb. 28, 2008

(54) Hand-held power tool with an air spring percussion mechanism having a crank drive

(76) Inventors: Reinhard Schulz, Munich (DE); Stefan Hammerstingl, Munich (DE); Damir Cehajic, Kempten (DE)

Correspondence Address: ABELMAN, FRAYNE & SCHWAB, 666 THIRD AVENUE, 10TH FLOOR, NEW YORK, NY, 10017, US

(21) Appl. No.: 11/811,318

(22) Filed: Jun. 7, 2007

(30) Foreign Application Priority Data
Jun. 8, 2006 (DE) 10 2006 000 279.2

(51) Int. Cl. B23Q 5/033

(52) U.S. Cl. 173/14

(57) ABSTRACT

A hand-held power tool has a air spring percussion mechanism which is suitable to provide for generating axial impacts by an impact piston reciprocating along an impact axis and which is driven by a crank pin (4) of a rotatably supported eccentric (5) whose mass distribution with respect to an eccentric axis (E) has an unbalance (U) which is offset in the eccentric plane extending perpendicular to the eccentric axis (E) by an angle of unbalance (φ) in the range of 70° to 90° relative to the crank pin (4) which is spaced from the eccentric axis (A) by a distance equal to the crank radius (K).

### BACKGROUND OF THE INVENTION

1. Field of the Invention

The invention is directed to a hand-held power tool with an air spring percussion mechanism with a crank drive and, particularly, to a multipurpose hammer or chisel hammer.

2. Description of the Prior Art

According to German Publication DE2511083, a conventional hand-held power tool of the type mentioned above has a crank mechanism that is driven by an electric motor and that includes an eccentric which is unbalance- compensated in a mirror-symmetric manner with respect to a crank radius and which moves an impact piston, which applies blows directly to a percussion tool, in oscillatory reciprocating motion by means of an air spring.

An air spring percussion mechanism of this kind generates high impact energies in a virtually reaction-free manner. Nevertheless, a small part of the vibrations is also transmitted to the external housing of the hand-held power tool, where it is ultimately absorbed, via the handle, by the user's hand/arm system.

Passive vibration damping, e.g., according to German Publication DE 19503526, or, in high-power hand-held power tools, also active vibration damping, e.g., according to European Publication EP 1221359, is often used in hand-held power tools of the type mentioned above for reducing vibrations of this kind at the handle.

According to the principle of superposition of forces, the vibration can be actively compensated to zero in theory, but only partially in practice, by correspondingly antiphase counterforces. With conventional nonharmonic vibrations, i.e., particularly non-sinusoidal vibrations with respect to time, this can be achieved by a sufficiently large quantity of harmonic counter-vibrations of different frequency, amplitude and phase when the latter are selected so as to be correspondingly in antiphase to the Fourier decomposition of the vibration.

Counterforces suited to this purpose occur, for example, in accelerated counter-oscillating masses. According to British Publication GB 969215, the vibration of the percussion mechanism in a hand-held power tool is compensated by counter-vibrations of a plurality of antiphase, harmonically oscillating masses of rotating eccentrics.

Since the main source of vibrations in air spring percussion mechanisms is the exclusively axially oriented, nonharmonic air spring force, exclusively axially oscillating masses are also suitable for compensation. The fundamental harmonic component of the air spring force is shifted in phase with respect to the crank motion. Therefore, according to European Publication EP 1475190, in a hand-held power tool with a crank-driven air spring percussion mechanism, the guide tube guiding the impact piston is driven by an additional eccentric so as to be shifted in phase by 270° relative to the driving piston and accordingly partially compensates the axially oriented fundamental harmonic component of the vibration.

Further, according to British Publication GB 474902, in a hand-held power tool with a crank-driven spring percussion mechanism, the guide tube for guiding the impact piston is moved in counter-phase to the driving piston by means of a nonround cam disk which is formed at the eccentric of the crank mechanism driving the driving piston.

### SUMMARY OF THE INVENTION

It is the object of the invention to realize a simply designed active vibration reduction for a hand-held power tool with a crank-driven, air spring percussion mechanism.

This and other objects of the present invention, which will become apparent hereinafter, are achieved with having percussion mechanism which is suitable for generating axial impacts of an impact piston reciprocating along an impact axis and which is driven by a crank pin of a rotatably supported eccentric whose mass distribution with respect to an eccentric axis has an unbalance that is offset in the eccentric plane extending perpendicular to the eccentric axis by an angle of unbalance in the rotating direction in the range of 70° to 90° relative to the crank pin which is spaced by a distance equal to the crank radius from the eccentric axis.

Owing to the unbalance which is arranged so as to be suitably asymmetric with respect to the crank pin, a portion of the fundamental harmonic oscillation of the vibration generated by the air spring percussion mechanism is compensated. Since the eccentric is a necessary component of the crank mechanism, no further structural component parts are required in principle, so that this active vibration reduction is simply designed and economical.

The unbalance with respect to the crank radius and the impact piston mass is in the range of 0.3 to 1.0 so that the unbalance is suitably dimensioned.

At an impact frequency in the range of 5 Hz to 25 Hz, the unbalance with respect to the crank radius and the impact piston mass is advantageously in the range of 0.4 to 1.0.

Alternatively, at an impact frequency in the range of 25 Hz to 60 Hz, the unbalance with respect to the crank radius and the impact piston mass is advantageously in the range of 0.35 to 0.9.

Alternatively, at an impact frequency in the range of 60 Hz to 100 Hz, the unbalance with respect to the crank radius and the impact piston mass is advantageously in the range of 0.3 to 0.8.

The eccentric advantageously has (considered in cylindrical coordinates) a crank disk which is directly adjacent to the crank pin along the eccentric axis and which has a mass distribution which is not rotationally symmetric in the eccentric plane and not mirror-symmetric with respect to the (vectorial) crank radius, so that the eccentric, which has this unbalance and is arranged close to the impact axis, generates only small tilting moments. Further, an eccentric, which is formed in this way, can be produced in a simple manner by casting or forging.

Alternatively, the eccentric advantageously has (considered in cylindrical coordinates) along the eccentric axis, in addition to a crank disk which is directly adjacent to the crank pin, an additional mass spaced therefrom with a mass distribution which is not rotationally symmetric in the eccentric plane and not mirror-symmetric with respect to the (vectorial) crank radius, so that an eccentric, which has this unbalance and is arranged close to the impact axis, generates additional tilting moments, which is especially suited for hand-held power tools having a center of gravity outside of the impact axis.

The eccentric advantageously has a plurality of parts, and an eccentric shaft is fixedly connected with a crank disc or with an additional mass, which is further advantageously formed as an eccentric ring, so that the eccentric can be formed of geometrically simple components.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a cross-sectional view of a hand-held power tool;

FIG. 2 a top view of a detail of the eccentric;

FIG. 3 a cross-sectional view of an embodiment of the eccentric along line III-III in FIG. 4; and

FIG. 4 a cross-sectional view of the eccentric shown in FIG. 3 along line IV-IV in FIG. 3.

### DETAILED DESCRIPTION OF THE PREFERRED EMBODIMENTS

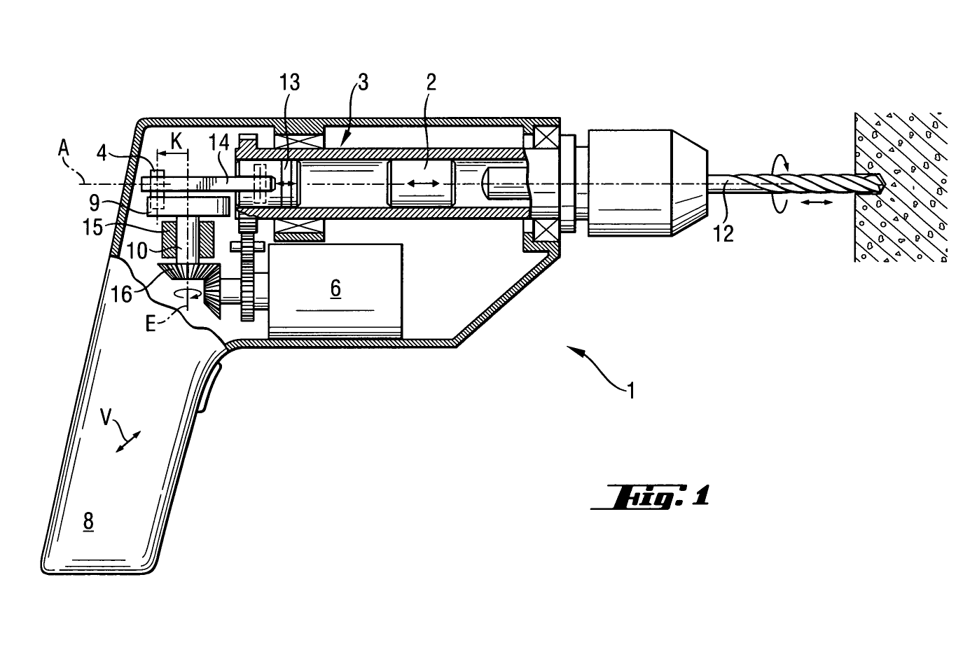

According to FIG. 1, a rotary percussion drilling hand-held power tool 1 has an air spring percussion mechanism 3 for applying axial blows to an impact piston 2 reciprocating along an impact axis A and impacting an impact tool 12. A small vibration V which is oriented diagonally to the impact axis A (generally periodically with respect to time) occurs at a handle 8 that is formed integrally with an external housing 7. The driving piston 13 which drives the air spring percussion mechanism 3 and reciprocates along the impact axis A, is connected, via a connecting rod 14, to a crank pin 4 of an eccentric 5 which is spaced by a crank radius K from an eccentric axis E and rotates around the eccentric axis E. The crank pin 4 is rotatably supported in a bearing 15 and is driven by an electric motor 6 via a pinion 16. The eccentric 5 has, along the eccentric axis E, a crank disk 9 located directly adjacent to the crank pin 4 and which is fixedly secured on an eccentric shaft 10.

According to FIG. 2, the crank disk 9, which is fixedly secured on the eccentric shaft 10 and which is shown in the eccentric plane oriented perpendicular to the eccentric axis E, has a contour that is not rotationally symmetric, and a corresponding mass distribution that is not mirror-symmetric with respect to the crank radius K which is (vectorially) directed to the crank pin 4. The eccentric 5 forms a resulting unbalance U (which is physically equivalent to a mass point of the eccentric 5, which is otherwise regarded as without mass, which mass point is at a distance corresponding in amount to the crank radius K and which is offset relative to the crank pin 4 by an angle of unbalance φ of 80° to the (vectorially) directed crank radius K.

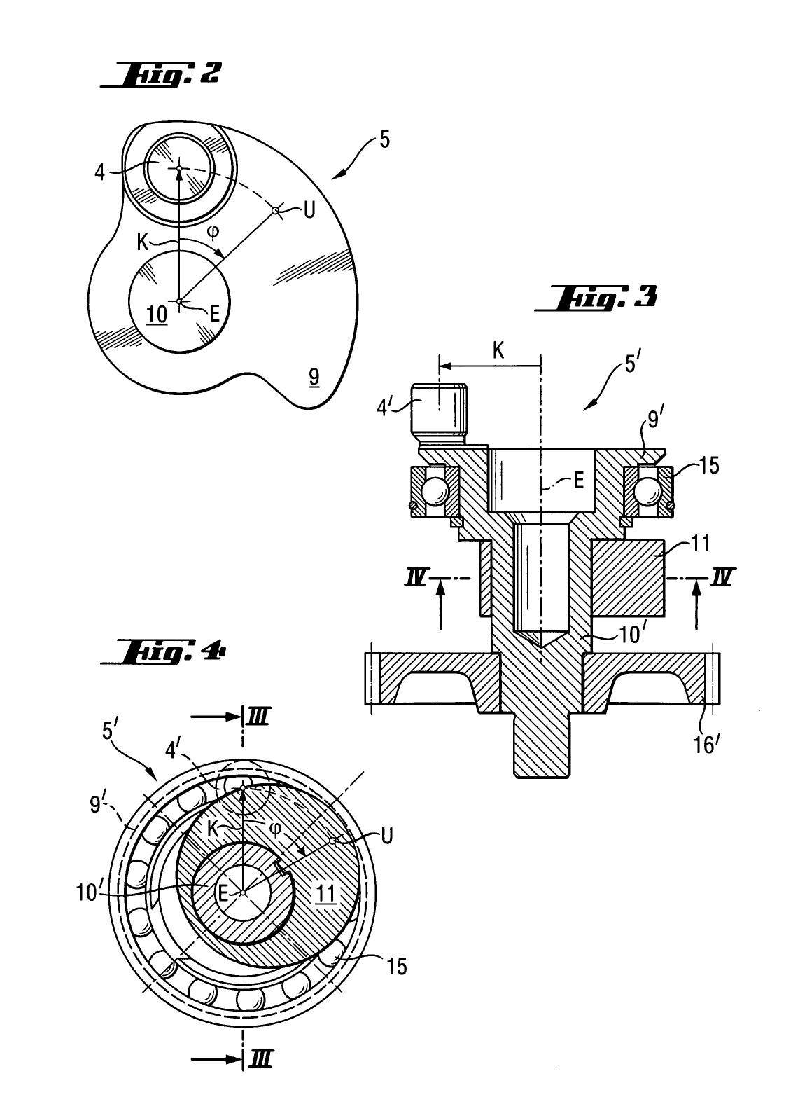

According to FIG. 3, an alternative eccentric 5′ has, in addition to a toothed gear 16′ and an eccentric shaft 10′ which is rotatably mounted in the bearing 15 and which has a crank disk 9′ is formed integrally therewith. The crank disc 9a carries, directly adjacent, the crank pin 4′ spaced by a distance of the crank radius K and an additional mass 11 which is spaced from the crank disk 9′ along the eccentric axis E.

According to FIG. 4, the additional mass 11 which is formed as an eccentric ring, has a contour that is not rotationally symmetric to the eccentric shaft 10′ in the eccentric plane, and a corresponding mass distribution which is not mirror-symmetric with respect to the crank radius K (vectorially) directed to the crank pin 4′. Thereby, the eccentric 5′ forms a resulting unbalance U (which is physically equivalent to a mass point of the eccentric 5′, which is otherwise regarded as without mass), which is offset relative to the crank pin 4′ by an angle of unbalance φ of 80° to the (vectorially) directed crank radius K. The eccentric 5′ is formed of multiple parts with the crank disk 5′ and the additional mass 11 and is fixedly mounted on the eccentric shaft 10 by a tongue and groove press fit.

The following dimensions are particularly suitable:

1) Impact frequency: 14 Hz; impact piston mass: 1400 g; crank radius: 4.7 cm; unbalance: 4000 g cm

2) Impact frequency: 50 Hz; impact piston mass: 170 g; crank radius: 1.7 cm; unbalance: 150 g cm

3) Impact frequency: 70 Hz; impact piston mass: 70 g; crank radius: 1.1 cm; unbalance: 40 g cm

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising an impact piston (2) reciprocating along an impact axis (A); an air spring percussion mechanism (3) acting on the impact piston (2) to generate axial impacts of the impact piston (2); and rotatably supported eccentric means (5, 5′) including a crank pin (4, 4′) for driving the air spring percussion mechanism (3), wherein mass distribution of the eccentric means has, with respect to an eccentric axis (E), an unbalance (U) that is offset, in an eccentric plane extending perpendicular to the eccentric axis (E), with respect to the crank pin (4, 4′), which is spaced from the eccentric axis (E) by a crank radius (K), by an unbalance angle (φ) that lies, in a rotational direction, in a range from 70° to 90°.

2. A hand-held power tool according to claim 1, wherein at an impact frequency in a range of 5 Hz to 25 Hz, the unbalance (U) with respect to the crank radius (K) and an impact piston mass is in a range of 0.4 to 1.0.

3. A hand-held power tool according to claim 1, wherein at an impact frequency in a range of 25 Hz to 60 Hz, the unbalance (U) with respect to the crank radius and an impact piston mass is in a range of 0.35 to 0.9.

4. A hand-held power tool according to claim 1, wherein an impact frequency in a range of 60 Hz to 100 Hz, the unbalance (U) with respect to the crank radius and a piston mass is in a range of 0.3 to 0.8.

5. A hand-held power tool according to claim 1, wherein the eccentric means (5) has a crank disk (9) located directly adjacent to the crank pin (4) along the eccentric axis (E) and having a mass distribution which is not rotationally symmetric in the eccentric plane and is not mirror-symmetric with respect to the crank radius (K).

6. A hand-held power tool according to claim 1, wherein the eccentric means (5′) has, along the eccentric axis (E), in addition to a crank disk (9′) which is located directly adjacent to the crank pin (4′), an additional mass (11) at a distance from the eccentric axis (A), with a mass distribution which is not rotationally symmetric in the eccentric plane and not mirror-symmetric with respect to the crank radius (K).

7. A hand-held power tool according to claim 5, wherein the eccentric (5, 5′) comprises a plurality of parts, and an eccentric shaft (10, 10′) is fixedly connected to the crank disk (9, 9′) or to the additional mass (11).
